(19) United States
(12) Patent Application Publication
(10) Pub. No.: US 2019/0370043 A1
(43) Pub. Date: Dec. 5, 2019

(54) COOPERATIVE MEMORY MANAGEMENT

(71) Applicant: Nutanix, Inc., San Jose, CA (US)

(72) Inventor: Jan Ralf Alexander OLDERDISSEN, Herrenberg (DE)

(73) Assignee: Nutanix, Inc., San Jose, CA (US)

(21) Appl. No.: 15/966,271

(22) Filed: Apr. 30, 2018

(51) Int. Cl. G06F 9/455; G06F 3/06

(52) U.S. Cl. CPC G06F 9/45558; G06F 3/0604; G06F 2009/45583; G06F 3/0664; G06F 3/0673; G06F 3/0631

(57) ABSTRACT

Systems for cooperative management of multiple types of memory. A method embodiment implements cooperative management of multiple types of memory among virtual machines running in a host computing system. The method commences upon identifying virtual machines and a hypervisor that runs in the host computing system. The hypervisor is configured to respond to memory allocation requests from the virtual machines. Upon receiving (a) a first memory allocation request for a first memory type having a first set of characteristics and (b) a second memory allocation request for a second memory type having a second set of characteristics, the hypervisor responds to the requestor with allocations from the first memory type and allocations from the second memory type. Different pools of memory are formed of the different types of memory devices. A multi-memory pool type combines memory devices of a first memory type and memory devices of a second memory type.

### FIELD

This disclosure relates to computing systems, and more particularly to techniques for cooperative memory management.

### BACKGROUND

Many modern computing systems implement multiple computing processes that carry out computing tasks. For example, a computing node of a distributed computing system might host hundreds of virtual machines (VMs) that perform specific computing tasks and/or run computing applications for their users. The computing processes access the computing resources of the computing system during execution of the computing tasks. For some computing processes, such as virtualized entities (VEs) or virtual machines, a virtual representation of the underlying computing resources is used in the course of carrying out the computing tasks. In particular, a VM might be allocated a certain amount of virtual memory space that is mapped (e.g., by a virtual page table) to a portion of the underlying physical memory.

In some cases, the virtual memory space can comprise virtual swap space that maps to a physical swap space on one or more physical devices that are managed by the host operating system or hypervisor or other agent of the computing system. As an example, the virtual memory might be backed by a high speed (and high cost) random access memory (RAM) device (e.g., DDR4 device) and the virtual swap space might be backed by a lower speed (and lower cost) random access persistent memory (RAPM) device (e.g., Intel Xpoint device). In other cases, the swap device might be an even slower (and even less costly) solid state drive (SSD) device or hard disk drive (HDD) device.

The amount of physical memory (e.g., RAM space) and/or swap space (e.g., hard disk drive space) that is allocated to a VM is often a fixed amount based on the expected peak needs of the computing processes running in the VM. For example, an initial allocation provided by the hypervisor might include 1.0 GB of RAM and 1.0 GB of allocated swap space. The guest operating system of the VM merely accepts the allocation amounts from the hypervisor or host operating system during a setup or initialization phase of the VM, and then operates within that constraint and without negotiation with the host operating system or hypervisor.

In spite of the fact that many different types of memory and storage devices are found in modern computing systems, and even though these different types of devices have different characteristics, because of historical deployments and historical limitations of operating systems there has been no way for processes running atop the operating system to manipulate these different types of memory.

Unfortunately, these limitations inherent in legacy host operating systems or hypervisors lead to suboptimal performance. Specifically, in the absence of communications and/or negotiations between the computing process and the underlying host operating system and/or hypervisor, the underlying host operating system and/or hypervisor would be unaware of any anticipated memory requirements of the computing processes, and thus cannot optimize system-wide memory allocations. What is needed is a way to avoid suboptimal apportioning of memory and storage resources in modern computing systems.

### SUMMARY

The present disclosure describes techniques used in systems, methods, and in computer program products for cooperative multiple memory type memory management, which techniques advance the relevant technologies to address technological issues with legacy approaches. More specifically, the present disclosure describes techniques used in systems, methods, and in computer program products for cooperative multiple memory type memory management. Certain embodiments are directed to technological solutions for implementing a framework to facilitate cooperative memory management by and between virtual machines and an underlying hypervisor in a computing system.

The disclosed embodiments modify and improve over legacy approaches. In particular, the herein-disclosed techniques provide technical solutions that address the technical problems attendant to efficiently managing the allocation of memory to multiple computing processes. Such technical solutions relate to improvements in computer functionality. Various applications of the herein-disclosed improvements in computer functionality serve to reduce the demand for computer memory, as well as to reduce the demand for computer processing power. Some embodiments disclosed herein use techniques to improve the functioning of multiple systems within the disclosed environments, and some embodiments advance peripheral technical fields as well. As one specific example, use of the disclosed computer equipment and constituent devices within the shown environments as described herein and as depicted in the figures provide advances in the technical field of computer memory management as well as advances in various technical fields related to virtualized computing.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A illustrates a computing environment in which embodiments of the present disclosure can be implemented.

FIG. 1B depicts an environment in which a memory management solver implements cooperative multiple memory type memory management optimizations as used in cooperative memory management systems, according to an embodiment.

FIG. 2 depicts memory management techniques as used in cooperative memory management systems, according to an embodiment.

FIG. 3 presents a block diagram of a system to implement cooperative memory management, according to an embodiment.

FIG. 4A, FIG. 4B, and FIG. 4C depict memory allocation techniques as implemented in systems that facilitate cooperative memory management, according to an embodiment.

FIG. 5 presents a memory reclassification technique as implemented in systems that facilitate cooperative memory management, according to an embodiment.

FIG. 6A and FIG. 6B illustrate page swapping scenarios as implemented in systems that facilitate cooperative memory management, according to an embodiment.

FIG. 7 illustrates a distributed virtualization environment in which embodiments of the present disclosure can be implemented.

FIG. 8A and FIG. 8B depict system components as arrangements of computing modules that are interconnected so as to implement certain of the herein-disclosed embodiments.

FIG. 9A, FIG. 9B, and FIG. 9C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of efficiently managing the allocation of memory to multiple computing processes. Some embodiments are directed to approaches for implementing a framework to facilitate cooperative memory management by and between virtual machines and an underlying operating system or hypervisor in a computing system. The accompanying figures and discussions herein present example environments, systems, methods, and computer program products for cooperative memory management.

### Overview

Disclosed herein are techniques for implementing a two-stage framework to carry out cooperative multiple memory type memory management operations between virtual machines and hypervisors in a computing system. In certain embodiments, the framework comprises a message bus over which the computing processes and operating systems communicate various memory/swap allocation messages. In such embodiments, the memory/swap allocation messages include computing process requests for a particular allocation of memory and swap space. The requests are interpreted as forecasts of future memory and swap space needs, and the operating systems fulfill the requests on a best-effort basis after considering all of the requests from all of the computing processes in the computing system.

In some cases, the hypervisors or operating systems may choose not to fulfill one or more requests. In such cases, the hypervisors or operating systems return a recommended allocation to each respective requesting computing process. The computing process considers the recommended allocation subject to its own forecasted (e.g., predicted) memory management needs, and either accepts the recommendation or requests another (e.g., smaller) memory allocation request. In certain embodiments, the memory/swap allocation messages include operating system requests for a certain amount of allocated memory to be released by one or more computing processes. In certain embodiments, the memory/swap allocation messages include computing process requests to reclassify (e.g., from main memory to swap memory) certain pages in memory. In certain embodiments, the framework facilitates cooperative multiple memory type memory management by a virtual machine and a hypervisor. In certain embodiments, the memory/swap allocation messages are invoked based at least in part on historical memory usage or performance and/or predicted memory usage or performance of the set of computing processes.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

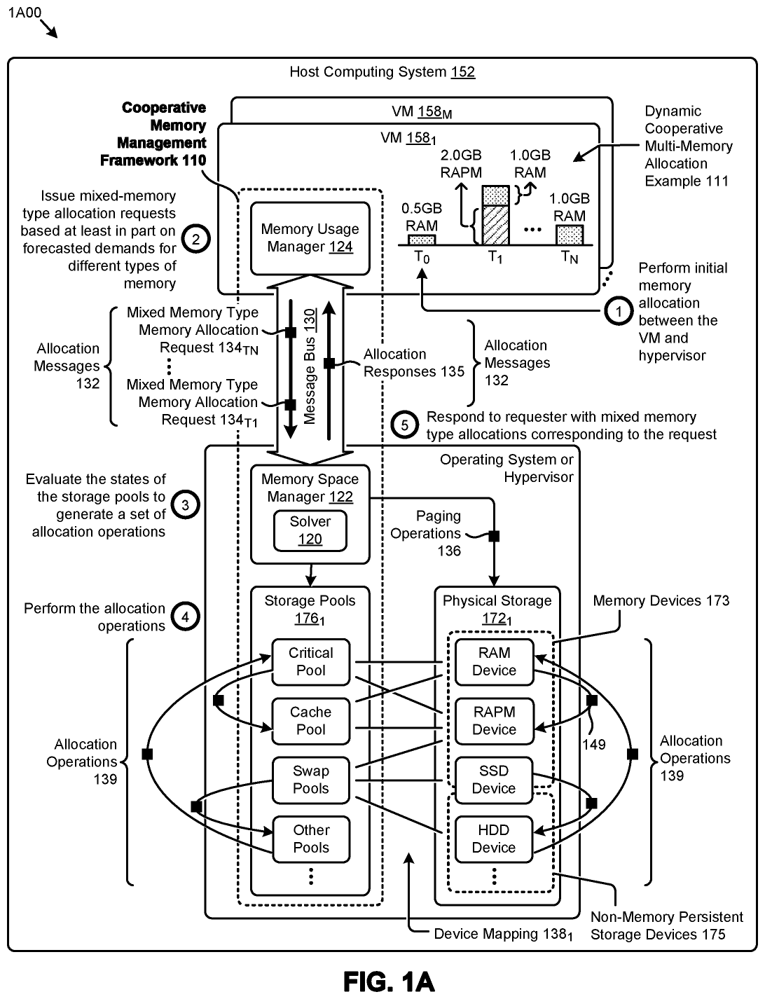

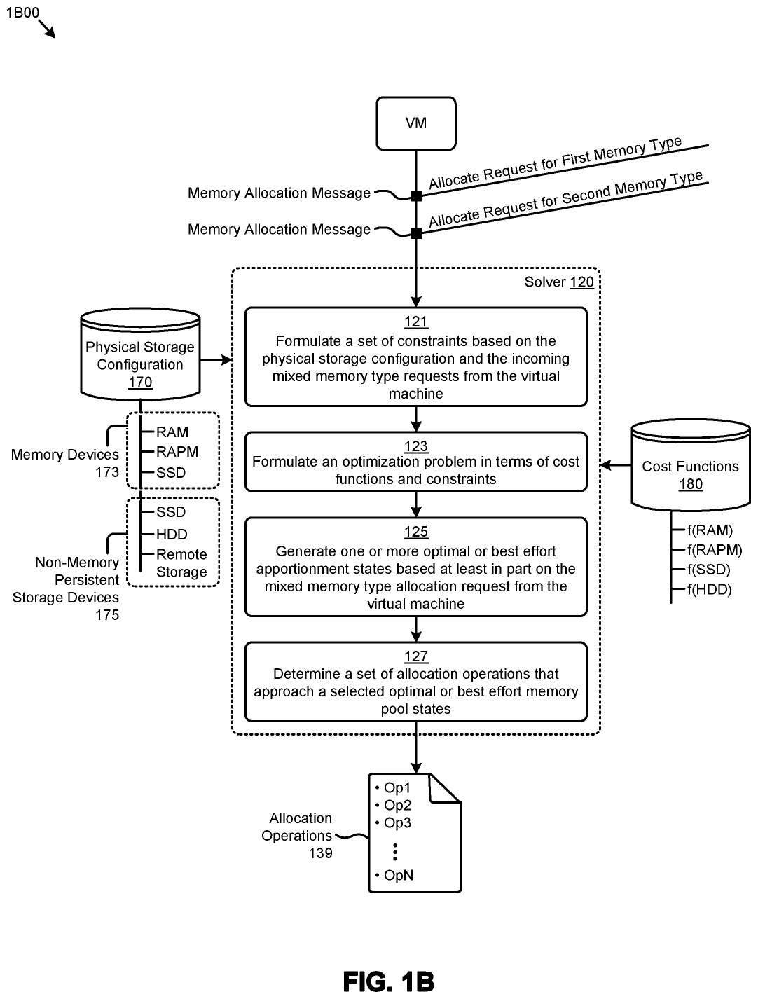

FIG. 1A illustrates a computing environment 1A00 in which embodiments of the present disclosure can be implemented. As an option, one or more variations of computing environment 1A00 or any aspect thereof may be implemented in the context of the architecture and functionality of the embodiments described herein.

FIG. 1A illustrates one aspect pertaining to implementing a framework to facilitate cooperative multiple memory type memory management by and between computing processes and an underlying operating system or hypervisor in a computing system. Specifically, the figure is presented to illustrate a framework that addresses the problem of efficiently managing the allocation of memory to multiple computing processes.

As depicted, computing environment 1A00 comprises a plurality of virtual machines (e.g., VM 158₁, . . . , VM 158_{M}) that can represent any computing process in the computing environment 1A00. The operation of the VMs is facilitated by a host computing system 152. The host computing system in turn provides the underlying physical computing resources that are shared by the VMs to carry out certain computing tasks such as running a set of applications. In particular, the VMs might be allocated a certain amount of virtualized memory and swap space from a portion of the storage pools 176₁ that are backed by a set of physical storage 172₁ at the host computing system 152. As an example, the virtual memory space might be backed by high speed (and high cost) memory devices 173 such as RAM devices (e.g., DDR4 devices) and RAPM devices, whereas the virtual swap space might be backed by a lower speed (and lower cost) non-memory persistent storage devices 175 such as SSD devices and/or HDD devices.

The amount of physical memory that is allocated to the VMs as virtual memory is often a fixed amount based on the expected peak needs of the VMs. Unfortunately, the dearth of communication pertaining to memory allocation between the VMs and underlying modules of the host computing system 152 (e.g., its hypervisor modules or host operating system modules) leads to suboptimal memory allocations between memory page pools. Specifically, some VMs might be “memory starved”, while other VMs might have received an over-allocation of memory relative to their actual computing needs.

The herein disclosed techniques address such problems pertaining to efficiently managing the allocation of memory to a plurality of VMs by implementing a cooperative memory management framework 110. Specifically, the cooperative memory management framework 110 comprises a message bus 130 over which the VMs and host computing system modules communicate. The message bus supports various types of memory/swap allocation messages from the virtual machines such as memory forecasts (e.g., mixed memory type memory allocation request 134_{T1}, . . . , mixed memory type memory allocation request 134_{TN}) and any forms of allocation responses 135. A virtual machine memory forecast is a memory amount that the virtual machine determines might be needed (or released) as pertains to future processing by the virtual machine. The virtual machine memory forecast can include a request for additional memory, or can include a request to release memory. In some cases, a virtual machine memory forecast is and/or includes a usage forecast (e.g., use of amounts of memory pages for sequential page access or for random page access, etc.).

A memory usage manager 124 at each of the VMs acts as an initiator of memory allocation/forecasting messages that are sent to the memory space manager 122. Also, the memory usage manager 124 at each of the VMs also acts as a receiver of memory/swap allocation messages from the memory space manager. Furthermore, the memory usage manager 124 monitors the then-current and forecasted memory requirements of the computing tasks (e.g., applications) running on the VMs to determine the nature of memory/swap allocation messages to be issued to the host computing system and/or to determine responses to messages received from the host computing system.

Each memory usage manager 124 at each of the VMs communicates with a memory space manager 122 at the host computing system 152. The memory space manager 122 receives memory/swap allocation messages from the VMs and responds with allocation responses 135 that are sent to the VMs. The memory space manager 122 also monitors the storage pools 1761 at the host computing system 152 to determine best effort or optimal memory allocations for the system and/or to determine individual responses to individual messages received from the VMs. As shown, communication between the memory usage manager and the memory space manager are carried out over the shown message bus component of the cooperative memory management framework.

As shown by the dynamic cooperative multi-memory allocation example 111, forecasting memory usage by a VM and providing that information to the memory space manager of the hypervisor or operating system gives the VM an opportunity to allocate sufficient memory for its needs without being greedy to the extent that other VMs would be “memory starved” as a consequence of a greedy allocation.

In the shown example, the VM receives an initial allocation of 0.5 GB of RAM at time=t0. This initial amount of memory is at least sufficient for the VM to initialize itself. When running (e.g., at a time=T1 that is some time after time=T0), the VM might request 1.0 GB of RAM and 2.0 GB of RAPM. At a later time, the VM might release the requested (and received) 2.0 GB of RAPM. Such requests (e.g., from the VMs) and responses (e.g., from the operating system or hypervisor) can be communicated using the shown cooperative memory management framework 110.

Operation of the shown message bus 130 is facilitated by the cooperative memory management framework 110. The framework, including its storage pools, its memory space manager, and its solver supports many different types of messages, which in turn provide sufficient information describing the memory requirements of each of the VMs. Upon receipt of such messages from the VMs, the operating system or hypervisor can make best-effort or optimized memory allocation decisions based on system-wide conditions. The best-effort or optimized memory allocation decisions based on system-wide conditions is informed by a combination of knowledge bases formed of VM forecasts as well as knowledge bases of the system that describe the underlying memory space and/or devices of the host computing system 152. Such combination of knowledge bases is not accessible using other memory allocation approaches.

The information exchange and best effort and/or optimal memory allocations that are facilitated by the herein disclosed techniques serve to reduce the system-wide demand for computer memory, as well as to reduce the demand for computer processing power. Specifically, continuous allocation and reallocation of computing system memory over multiple computing processes can reduce the amount of allocated memory that is unused (e.g., wasted) by the computing processes. Moreover, efficient memory allocations can improve the collective performance of the computing processes by providing the right amount of memory and the right type of memory to the computing processes when needed.

As an example, the scenario illustrated in FIG. 1A shows that the storage pools 176₁ can be configured to have various types of pools. As can be observed, the storage pools 176₁ might have pools of data pages that are respectively characterized as “Critical”, “Cache”, “Swap”, “General” and/or other types of pools. The memory page pools can be backed by a particular type (or types) of physical memory as indicated by device mapping 138₁. For example, the “Critical” pages might be backed by the highest performance (e.g., lowest latency) memory type (e.g., RAM device), whereas the “Swap” pages might be backed by a lower performance memory type (e.g., SSD device or HDD device).

At initialization time (e.g., at time=T0), a VM 1581 might indicate an initial memory allocation amount (operation 1). Then, at some later point in its operation, VM 158₁ might issue one or more memory usage forecasts in the form of memory/swap allocation messages 132 (e.g., via memory usage manager 124) based on its then-current and/or forecasted memory usage needed to perform upcoming computing tasks (operation 2). For example, an application running on VM 1581 might have a forthcoming need for a set of “Critical” data pages (e.g., to hold a data table over which many computing operations are to be performed). Also, the VM 158₁ might have a very large table that is needed for random access, but only periodically. The memory space manager 122 at the host computing system 152 will consider these two different types of needs and will then determine one or more memory/storage allocation operations that will, when executed, achieve a best fit or optimal memory pool configuration (operation 3). In the foregoing example, the forecasted need for some critical data pages might result in an allocation of an area of a RAM device to fulfill the need. Also, the forecasted need for low latency—but only periodic access to a large table—might result in an allocation of one or more areas of a RAPM device. Such needs involving different memory types can be communicated using allocation messaging in a framework that, for example, supports messaging between a virtual machine and its hypervisor.

The shown allocation messages can comprise any forms of mixed memory type memory allocation requests and/or any forms of allocation responses 135. The message bus 130 facilitates communication between a virtual machine and an operating system or hypervisor. In traditional process/OS settings, memory demands were communicated by having the process execute a system call (e.g., ‘malloc( )’ which reached the kernel and/or memory manager of the OS. The OS in turn responded with a value that was communicated back to the requesting process by placing the return value on the stack of the calling process.

However, when in a virtualized environment, a communication technique such as the foregoing does not apply, at least since virtual machines operate over a hypervisor, which in turn operates over a host operating system. As such embodiments as disclosed herein communicate memory and/or swap needs by sending messages over a message bus. As shown, the message bus facilitates communication between a memory usage manager 124 of the virtual machine and a memory space manager 122 of the shown operating system or hypervisor. Any known technique can be used to communicate messages. Strictly as examples, messaging can be accomplished by posting contents of memory to a share area, and then raising an interrupt such that the recipient is notified to access the message. Other techniques such as message passing via rings and/or queues are possible.

In some cases, all of the then-current pending requests received from all of the VMs can be satisfied as requested. In other cases, the request or requests might be satisfied in part (or not at all) depending on the other then-current pending requests and the then-current state of the memory pools. As such, the memory space manager 122 includes a solver 120 that solves for an optimal or near-optimal memory pool configuration that is based on a multi-variable solver having at least two cost-oriented objective functions and a set of constraints. The at least two cost-oriented objective functions comprise a first cost-oriented objective function pertaining to a first memory type and a second cost-oriented objective function pertaining to a second memory type.

In the example case shown in FIG. 1A, the received request results in a set of memory/storage allocation operations 139 that are performed over the storage pools 176₁ (operation 4). In one exemplary situation, memory/storage allocation operations 139 are performed between two different types of memory. One specific allocation type moves, for example, a large set of RAM device pages (e.g., comprising a large data structure) to a set of pages in a RAPM device. This can happen, for example, when the virtual machine can forecast that it would not need the aforementioned large set of RAM device pages for some foreseeable duration. As such the VM can issue a memory forecast via a mixed memory type memory allocation request. In this specific case, the mixed memory type memory allocation request might indicate a release of the space from a first memory type (e.g., the RAM that holds the large data structure) as well as an indication that space of a second memory type is being requested. As such the RAM pages can be moved to RAPM pages as shown by movement 149. A corresponding notation is made on the affected storage pools.

The foregoing different types of memory might be different as pertains to the technologies used in the underlying memory cells. For example, a RAM cell might use a group of transistors, while a different type of memory might use a memristor. As another possibility, a first memory type might have different performance characteristics as compared to a second memory type. As another possibility, a first memory type might have different cost characteristics as compared to a second memory type. As yet another possibility, a first memory type might have different capacity characteristics as compared to a second memory type. In any of the foregoing possibilities, the hypervisor can discriminate a request for a first memory type as compared to a request for a second memory type when processing a memory allocation requests from a virtual machine. In some cases, the header and/or addressing and/or entry point of the call or request itself is indicative of the type of memory being requested.

The memory space manager, possibly in conjunction with the solver, is able to manage all varieties of moves and/or copies between any of the variety of memory types. Moreover, the memory space manager, possibly in conjunction with the solver, is able to manage all moves and/or copies between memory devices and non-persistent storage devices. Furthermore, the memory space manager, possibly in conjunction with the solver, is able to manage all varieties of moves and/or copies between any of the varieties of storage pools. Specifically, and as shown, one or more pages are moved from a “General” page pool to a “Critical” page pool. Also depicted in this same example is the movement of memory pages from “Critical” to “Cache”, and from “Swap” to “General”. The host computing system 152 then responds to VM 158₁ with the new page addresses (operation 5) so as to facilitate use by VM 158₁ of the newly assigned memory pages.

In the performance of operation 3, a set of memory/storage allocation operations are determined. As the set of memory/storage allocation operations are executed, the memory space moves toward a state that achieves the determined best fit or optimal memory pool configuration. In order to determine one or more best fit or optimal memory pool configurations, and in order to generate a set of memory/storage allocation operations that serve to approach such a best fit or optimal memory pool configuration, a solver 120 is employed. One embodiment of such a solver is presented in FIG. 1B. As used herein, the memory/storage allocation operations are steps that can be taken in an order so as to achieve a reapportionment of memory to memory pools. Paging operation can be taken to move data from one physical memory device to another physical memory device. As such, a set of paging operations can accomplish re-apportionment of memory to various memory pools.

FIG. 1B depicts an environment 1B00 in which a memory management solver implements cooperative multiple memory type memory management optimizations, according to an embodiment. As an option, one or more variations of environment 1B00 or any aspect thereof may be implemented in the context of the architecture and functionality of the embodiments described herein.

As earlier indicated, memory optimization problems can be expressed as a multi-variable problem that can be solved to an optimal or near-optimal solution using a solver 120 that considers combinations of characteristics of a physical storage configuration 170 (e.g., how much and what types of memory devices and non-memory devices are physically installed), one or more cost functions 180, and one or more constraints (e.g., performance minimums, allocation minimums, etc.). The cost functions 180 might comprise multiple cost functions for each type of device type. In some cases, the cost functions 180 comprise cost functions for each type of storage pool.

As shown, the solver 120 commences at step 121 that receives one or more memory/swap allocation messages from a VM. The receipt invokes processing that formulates constraints based on the physical storage configuration 170 and/or other system configuration data. The physical memory configuration might be static (e.g., based solely on physically installed memory components), or the physical memory configuration might be dynamic (e.g., when a device such as a RAPM can be reconfigured on-the-fly to be apportioned into an area that behaves as a random access memory and another area that behaves as a block-oriented device).

Then, at step 123, an optimization problem is formulated. The optimization problem includes characteristics of a multi-variable problem that can be solved to an optimal or near-optimal solution using a combination of cost functions 180 and constraints. More specifically, the solver has access to at least one cost-oriented objective function that pertains to a first memory type and at least another cost-oriented objective function that pertains to a second memory type. When forming a multi-variable problem, the solver can access the physical storage configuration 170 so as to determine the capacities (e.g., amounts of memory) available in each of the different types of memory devices 173, as well as to determine the capacities (e.g., amounts of non-memory storage) available in each of the different types of non-memory persistent storage devices 175.

Once such a multi-variable problem has been formulated, a module is invoked (at step 125) to determine one or more memory pool states that are deemed to be feasible (e.g., based on satisfaction of the aforementioned constraints) as well as optimal or near-optimal (e.g., based on cost functions for the corresponding different types of memory in the request). Operation of the aforementioned module serves to generate one or more optimal or best effort memory pool apportionment states.

In addition to determination of the optimal or best effort memory pool states, techniques are needed to move from a then-current state to a desired state. This can be accomplished using any known techniques. Specifically, and as shown, at step 127, an ordered set of memory/storage allocation operations is formed. The solver can then determine the specifics of the nature of the memory/storage allocation operations (e.g., how many pages to move from one place to another). The solver can also specify an order for carrying out the memory/storage allocation operations. An ordered set of memory/storage allocation operations can be codified into a document (e.g., comprising a list or sequence specification) that can then be carried out by the operating system or carried out by hypervisor functions.

The foregoing solver is merely one techniques that can be used for cooperative memory management. Details pertaining to use of a solver 120 and/or the aforementioned cooperative memory management framework 110 are disclosed in further detail as follows.

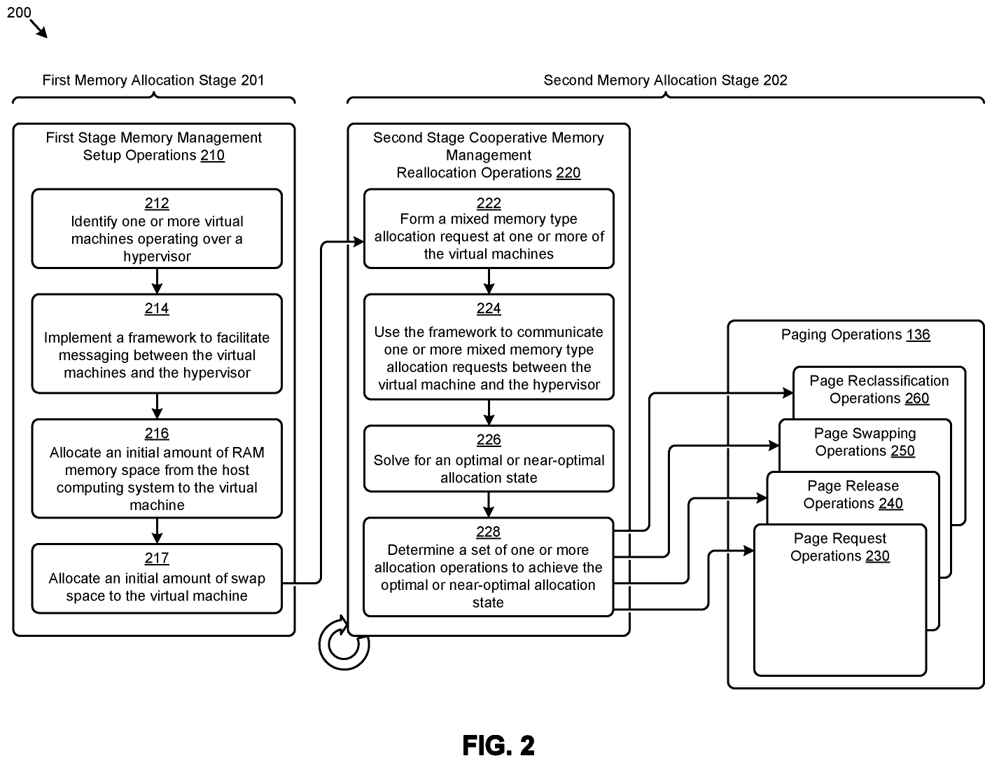

FIG. 2 depicts memory management techniques 200 as used in cooperative memory management systems. As an option, one or more variations of memory management techniques 200 or any aspect thereof may be implemented in the context of the architecture and functionality of the embodiments described herein. The memory management techniques 200 or any aspect thereof may be implemented in any environment.

The memory management techniques 200 presents one embodiment of certain steps and/or operations that facilitate efficiently managing the allocation of memory to multiple computing processes. As shown, a first portion of the steps and/or operations comprise a set of first stage memory management setup operations 210, and a second portion of the steps and/or operations comprise a set of second stage cooperative memory management reallocation operations 220. The first stage memory management setup operations 210 can commence by identifying one or more virtual machines operating on a host computing system (step 212). For example, the virtual machines might be a set of VMs over a particular hypervisor, or might be other virtualized entities (e.g., executable containers) or computing processes that interact with one or more hypervisors on a computing node of a distributed computing system.

A framework is implemented to facilitate, at least in part, messaging between virtual machines and its hypervisor (step 214). Such messaging can comprise messages (e.g., requests, responses, calls, etc.) issued by either the computing processes or the host computing system using an application programming interface (API) known by the computing processes and the host computing system. In a first stage of memory allocation, an initial amount of memory space from the host computing system is allocated to the virtual machine (step 216), and in this first stage of memory allocation, an initial amount of swap space from the host computing system is allocated to the virtual machine (step 217). As an example, an initial amount of RAM memory might be based on a minimum amount of memory needed to carry out a minimum set of virtual machine initialization functions. Or, in a greedy allocation scenario, this initial amount might be based on a maximum that the VM or its designer deems to be needed as an initial amount. As another example, an initial amount of RAPM memory might be based on the amount or RAM memory that had been initially allocated. Or, in a greedy allocation scenario, this initial amount might be based on a maximum amount.

This initial, first stage amount can be modified at will by the VM through use of any number of subsequent memory/swap allocation messages that are exchanged between the virtual machine(s) and the underlying operating system or hypervisor. The specific modification to a memory allocation is based at least in part on any number of reallocation operations that might be performed by memory space manager 122. Any particular occurrence of one or more memory/swap allocation messages 132 raised by a VM might initiate a negotiation between the virtual machine(s) and the underlying operating system or hypervisor, which negotiations result in second stage cooperative memory management reallocation operations.

In this specific embodiment, the second stage cooperative memory management reallocation operations 220 can commence by detecting (at step 222) a mixed memory type memory allocation request raised by a virtual machine. The memory allocation request might be received by one or more modules of the host computing system. For example, a message ring processor of the host computing system might process a next incoming message corresponding to the memory allocation event. The message might include a then-current or forecasted need for more data pages of a certain first type of memory (e.g., RAPM pages), and the message might include a release of a certain type of memory (e.g., RAM).

Responsive to any such memory allocation events, one or more memory/swap allocation messages can be communicated over the framework (step 224). In the foregoing examples, the computing process might add more pages to its “Cache” page pool, or the host computing process might request that one or more computing processes release some of their “Critical” pages to relieve the oversubscription. One or more memory/storage allocation operations, determined based at least in part on the memory/swap allocation messages, are then performed (step 226). The solver can communicate with a message ring processor of the host computing system so as to pull off multiple incoming messages at one time, and attempt to find an optimal or near optimal memory allocation solution that covers the multiple incoming requests. In some cases, a first message refers to a first memory type and a second message refers to a second memory type.

As earlier mentioned, such operations may not completely fulfill a particular request, but may merely represent a “best-effort” response after considering all of the requests from all of the computing processes. In some cases, the host computing system may return a recommended allocation to each respective requesting computing process. At step 228, based at least in part on the optimal or near optimal memory allocation of step 226, a set of memory/storage allocation operations are prescribed. The memory/storage allocation operations often involve paging operations 136, which paging operations might be responsive to one or more page request operations 230 (e.g., responsive to a memory allocation message from a VM), and/or the paging operations 136 might include any one or more of page release operations 240, particular types of page swapping operations 250, or particular types of page reclassification operations 260, any of which operations might allocate/release pages to/from one or another type of memory and/or move pages from one type of memory to another type of memory.

Performance of the combination of operations of the first memory allocation stage 201 in combination with performance of at least some of the operations of the second memory allocation stage 202, the cooperative memory management reallocation operations 220 can achieve ongoing optimal or near-optimal system-wide memory allocations in many types of computing systems. One particular computing system for implementing the memory management techniques 200 including variations of the first memory allocation stage 201 and/or second memory allocation stage 202 is disclosed as follows.

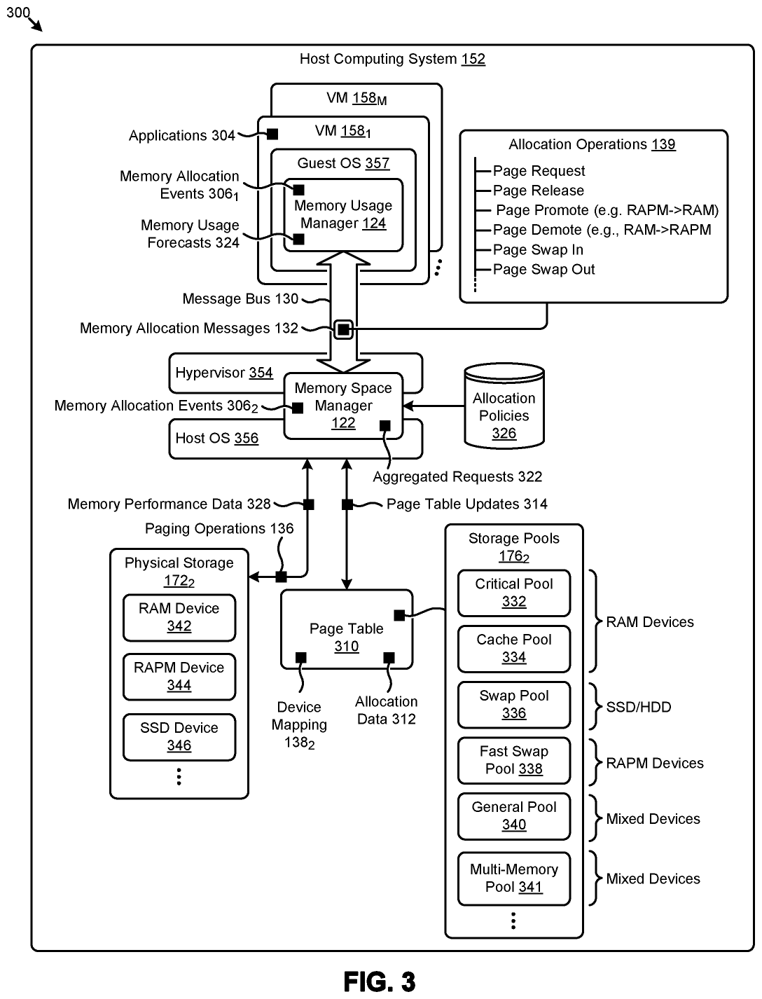

FIG. 3 presents a block diagram of a system 300 to implement cooperative memory management. As an option, one or more variations of system 300 or any aspect thereof may be implemented in the context of the architecture and functionality of the embodiments described herein. The system 300 or any aspect thereof may be implemented in any environment.

FIG. 3 illustrates one aspect pertaining to implementing a framework to facilitate cooperative memory management by and between computing processes and an underlying operating system or hypervisor in a computing system. Specifically, the figure is being presented to show one embodiment of the components and associated data flows that facilitate efficient allocation of memory to multiple computing processes. The components and data flows shown in FIG. 3 present one partitioning and associated data manipulation approach. The specific example shown is purely exemplary, and other subsystems, data structures, and/or partitionings are reasonable.

Specifically, the system of FIG. 3 presents a more detailed instance of a host computing system 152 that facilitates the operation of the VMs (e.g., VM 158₁, . . . , VM158_{M}) earlier described. The memory usage manager 124 is shown in this embodiment as implemented in the guest operating system (e.g., guest OS 357) of VM 158₁ . The memory space manager 122 is also shown as implemented in a hypervisor 354 and/or a host operating system (e.g., host OS 356) of host computing system 152. Instances of the memory usage manager 124 (e.g., at each VM) and instances of the memory space manager 122 (e.g., at each hypervisor and/or host OS and/or host computing system) communicate over the message bus 130 according to the herein disclosed techniques. One example implementation of message bus 130 can be facilitated by the “virtio” framework (not shown). The virtio framework is a paravirtualized framework in which the virtualized entity (e.g., VM 158₁) is aware that it is running on a hypervisor (e.g., hypervisor 354). The virtio specification defines the drivers and API calls over which the virtualized entity and hypervisor can communicate. Other implementations of message bus 130 are possible.

The physical storage 1722 is available at the host computing system 152 to support the operation of the computing processes (e.g., VMs). As can be observed, the physical storage 1722 can comprise a RAM device 342, a RAPM device 344, an SSD device 346, and/or other devices. The memory space manager 122 accesses any of the devices of the physical storage 1722 to issue instances of paging operations 136 (e.g., to the kernel or portion of the kernel of the host OS 356 stored on the RAM device 342) and/or to receive certain instances of memory performance data 328 (e.g., memory usage levels, etc.).

The memory space manager 122 manages, at least in part, the storage pools 176₂ of the host computing system 152 using a page table 310. The page table 310 can facilitate organizing the storage pools 176₂ into multiple pools of data pages of varying types. The page table 310 codifies the then-current memory allocations as a set of allocation data 312.

In the embodiment of FIG. 3, the storage pools 176₂ comprise a critical pool 332, a cache pool 334, a swap pool 336, a fast swap pool 338, a least recently used pool (e.g., an LRU pool), a general pool 340, a multi-memory pool 341, and/or other memory page pools. Other constituencies of the storage pools (e.g., with more or fewer pool types) are reasonable. The critical pool 332 might comprise data pages that are known to the hypervisor 354 and/or the host OS 356 as being heavily used or used in latency-sensitive code paths. The cache pool 334 might comprise data pages that are used to store cached data that can be readily retrieved at a later time. In some cases, the cache pool 334 might be subdivided to distinguish between the foregoing “non-dirtyable” data pages and “dirtyable” data pages that hold cached data that may not be readily retrieved at a later time. The swap pool 336 might comprise data pages that are not expected to be accessed for an extended period of time, whereas the fast swap pool 338 might comprise data pages that are indeterminate as to when or whether or not they are expected to be accessed.

The LRU pool might comprise data pages that are known to be seldom used. Pages in the LRU pool might be pages that are used by inactive drivers or by portions of the host OS 356 and/or the guest OS 357 that are inactive. For example, certain portions of application code that are known to be used only on application launch might be stored in the LRU pool. The page pools of storage pools 176₂ can be backed by a particular type (or types) of devices from physical storage 172₂ as indicated by a device mapping 138₂ codified in page table 310. For example, critical pool 332 might be backed by RAM device 342 and even a portion of RAPM device 344, whereas the general pool 340 might be backed by SSD device 346.

The shown storage pools 176₂ includes a multi-memory pool 341. This pool is backed by backed by two different types of devices from physical storage. In one specific example, the makeup of the multi-memory pool 341 straddles a first memory type and a different second memory type, where the first memory type is faster, but more expensive, and the second memory type, although slower than RAM, is less expensive. This straddling capability supports a variety of use cases, including use cases that arise when the operating system or hypervisor is executing legacy applications. In such cases, the legacy applications can use two different types of memory, even though the legacy code does not explicitly specify such two different types of memory (e.g., if the legacy code was written and/or compiled before deployment of the herein-disclosed multi-memory allocation techniques).

The allocation of memory areas of the multi-memory pool 341 that straddles a first memory type and a different second memory type means that an application does not have to explicitly allocate areas from a first memory type and areas from a different second memory type. Instead, even in the absence of explicit indications from the requestor, the memory space manager 122 can allocate a first portion from an area backed by a first memory type and can allocate a second area that is backed by a second memory type. The memory space manager 122 can do this based on information available to the memory space manager, some of which can be determined from characteristics and/or settings and/or a state of the operating system or hypervisor. Strictly as one example, memory areas from two different memory types can be allocated based on a request and/or history from a virtual machine or other process that accesses a database.

Specifically, an apportionment of an in-memory database can be automatically partitioned into an index portion and a table portion. One optimal or near optimal apportionment is to locate the database index in RAM memories and the tables in RAPM memories. In some embodiments, the memory space manager 122 can recognize that the database can be apportioned into an index portion and a table portion. In another embodiment, a solver, acting as an agent of memory space manager 122, can recognize that the database can be so apportioned into an index portion and a table portion. In some situations, even after a database has been apportioned as an index portion in RAM and as a table portion in RAPM, the memory space manager can determine to keep the index and tables in the multi-memory pool, or the memory space manager can decide to move any or all of the index portion and/or the table portion into other pools. This can happen when access to a database goes inactive. The history as aforementioned above can be used to determine if the access to memory pages that correspond to a database have become more infrequent or inactive. Such a history can be maintained on an ongoing basis.

Further details regarding general approaches to page usage tracking are described in co-pending U.S. patent application Ser. No. 15/891,751 titled “HARDWARE-ASSISTED PAGE ACCESS TRACKING”, filed Feb. 8, 2018, which is hereby incorporated by reference in its entirety.

Further details regarding general approaches to use of RAPM devices in multi-tiered swap spaces are described in co-pending U.S. patent application Ser. No. 15/901,441 titled “MANAGING MULTI-TIERED SWAP SPACE”, filed Feb. 21, 2018, which is hereby incorporated by reference in its entirety.

The memory usage manager 124 tracks a set of memory usage forecasts 324 and/or any other sorts of memory allocation requests and issues and/or responds to instances of memory/swap allocation messages 132 based at least in part on such forecasts or memory allocation requests. The memory usage forecasts 324 might be derived from the then-current and/or forecasted computing tasks of a set of applications 304 running at VM 158₁. Such forecasts can trigger certain memory allocation events 3061 at VM 158₁ which, in turn, trigger one or more memory/swap allocation messages 132 to be issued to the memory space manager 122 of the host computing system 152. For example, a forecast for “critical” pages at VM 158₁ that exceeds the then-current allocation of data pages from the critical pool 332 produces a memory allocation event that triggers a request for an allocation of additional pages from the critical pool. At the host computing system 152, the memory space manager 122 considers a set of aggregated requests 322 from various computing processes (e.g., VM 158₁, . . . , VM 158_{M}) and issues and/or responds to instances of memory/swap allocation messages 132 based at least in part on the aggregated requests.

In some cases, the then-current allocations captured in the allocation data 312 and/or certain instances of the memory performance data 328 are considered when issuing and/or responding to memory/swap allocation messages. In other cases, certain memory allocation events 3062 can trigger one or more memory/swap allocation messages 132 to be issued to the memory usage manager of one or more of the VMs. For example, a breach of a usage threshold of a particular memory page pool might produce a memory allocation event that triggers a request to one or more VMs to release pages associated with that particular page pool.

As can be observed, memory space manager 122 has access to a set of allocation policies 326. The allocation policies can be accessed, at least in part, to facilitate resolving allocation conflicts that may occur when sharing a limited resource (e.g., any of the devices of physical storage 172₂) over multiple resource consumers (e.g., computing processes, VMs, etc.). A wide variety of such allocation policies are conceivable. For example, allocation policies 326 might indicate that an equal or configurable base number of pages be allocated to each VM, with any pages in excess of that base number allocated (e.g., according to the herein disclosed techniques) until depleted. Another possibility would be to impose a limit of the maximum amount of memory that can be allocated to any VM. Yet another possibility would be to allow an administrator to set VM-specific bounds (e.g., a lower bound and/or an upper bound). Also possible is assigning priorities to VMs, such that a request for memory of a given type by a higher priority VM will be served preferentially, possibly at the cost of determining lower priority VM usages, and sending certain of those lower priority VMs requests to release previously allocated pages. In some cases, a lower priority VM can be stopped and/or unloaded if or when the lower priority VMs either refuse to honor the release requests and/or are unable to release requested pages. Still other allocation policies are possible.

In certain embodiments, one or more memory/storage allocation operations can be determined and/or performed based at least in part on the memory/swap allocation messages 132. Such memory/storage allocation operations can be carried out by any combination of paging operations 136, page table updates 314, and/or other actions. As shown in the memory/storage allocation operations 139, such operations might include a page request operation, a page release operation, a page promote operation, a page demote operation, a page swap in operation, a page swap out operation, and/or other operations. Further details describing memory/storage allocation operations facilitated by the herein disclosed techniques are described as follows.

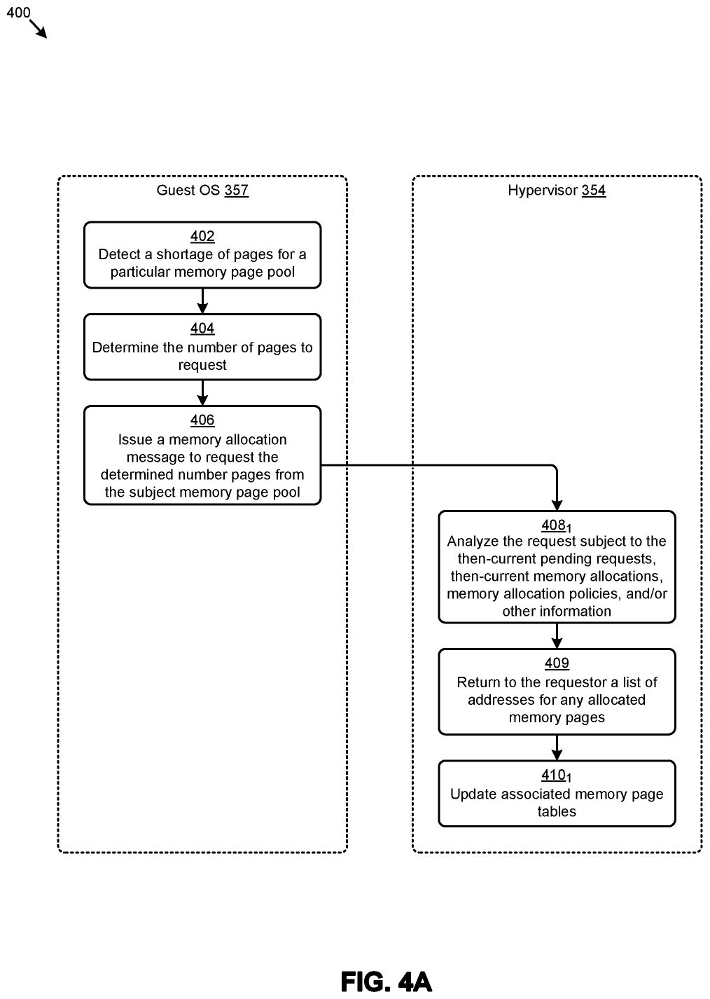

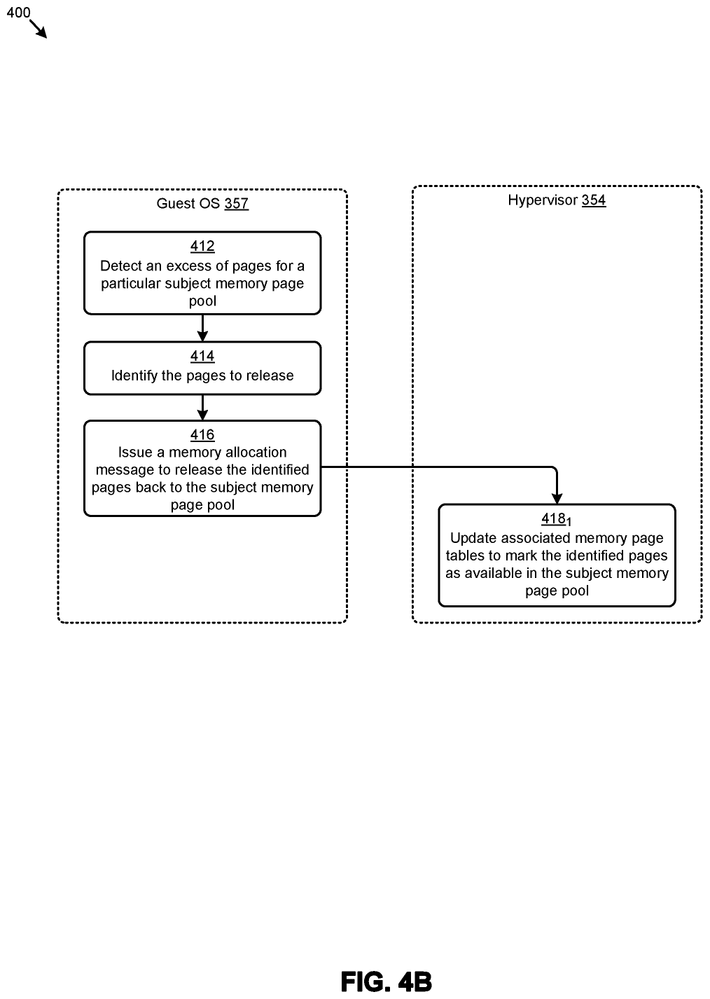

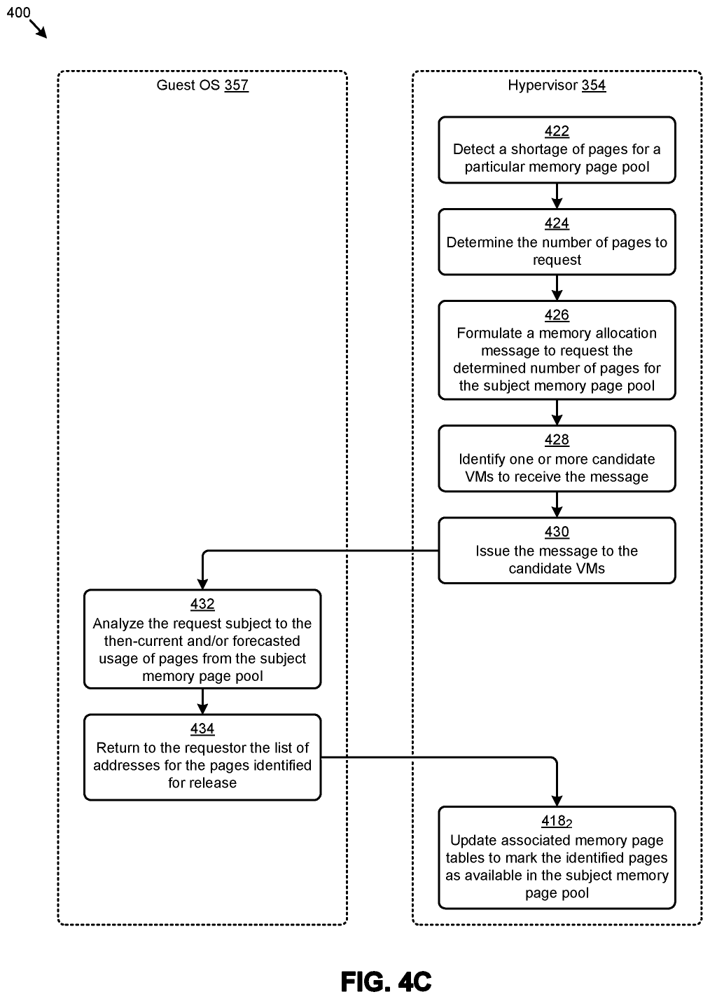

FIG. 4A, FIG. 4B, and FIG. 4C depict memory allocation techniques 400 as implemented in systems that facilitate cooperative memory management. As an option, one or more variations of memory allocation techniques 400 or any aspect thereof may be implemented in the context of the architecture and functionality of the embodiments described herein. The memory allocation techniques 400 or any aspect thereof may be implemented in any environment.

FIG. 4A, FIG. 4B, and FIG. 4C illustrate one aspect pertaining to implementing a framework to facilitate cooperative memory management by and between computing processes and an underlying operating system or hypervisor in a computing system. Specifically, the figures are presented to illustrate embodiments of certain steps and/or operations that perform page request operations and page release operations according to the herein disclosed techniques. Specifically, FIG. 4A, FIG. 4B, and FIG. 4C illustrate various memory allocation techniques that carry out steps to implement cooperative memory allocation between a guest OS and a hypervisor so as to implement various page request and page release operations.

As shown in memory allocation techniques 400, a first portion of the steps and/or operations can be executed at guest OS 357 (e.g., of a VM), and a second portion of the steps and/or operations can be executed at hypervisor 354. Referring to FIG. 4A, the memory allocation techniques 400 can commence by the guest OS 357 detecting a shortage of pages for a particular memory page pool (step 402). The number of pages required is determined (step 404), and a memory allocation request for the determined number of pages from the subject memory page pool is issued (step 406). The hypervisor 354 analyzes the request subject to the other then-current pending requests, the then-current memory allocations, the memory allocation policies, and/or other information (step 408₁). A list of the addresses for any allocated memory pages is returned to the requestor (e.g., guest OS 357) (step 409), and any associated page tables are updated (step 410₁). In some cases, the list of addresses may be empty, or include addresses corresponding to a number of pages smaller than the number of requested pages. The page tables that are updated by hypervisor 354 might include the virtual memory table (not shown) belonging to guest OS 357. In many computing scenarios, a page request made by a VM might be a greedy request, however, in many of those same scenarios, receiving a number of pages that is smaller than the number of requested pages can reduce the computing resources consumed by the guest OS without negatively impacting performance of the VM.

Referring to FIG. 4B, an excess number of allocated pages for a particular memory page pool can be detected at guest OS 357 (step 412). The excess pages are identified (step 414) and a memory allocation message to release the identified pages back to the subject memory page pool is issued (step 416). The hypervisor 354 updates the associated page tables to mark the identified pages as available in the subject memory page pool (step 418₁).

Referring to FIG. 4C, hypervisor 354 detects a shortage of pages for a particular memory page pool (step 422). The number of pages required is determined (step 424). A memory allocation message is formulated to request the determined number of pages for the subject page pool (step 426). The hypervisor 354 identifies one or more candidate VMs (e.g., the VM associated with guest OS 357) to receive the message (step 428) and issues the message to the candidate VMs (step 430). The guest OS 357 analyzes the request subject to the then-current and/or forecasted usage of pages from the subject page pool (step 432). A list of addresses for the pages identified for release (if any) are returned to the requestor (step 434). The hypervisor 354 updates the associated page tables to mark the identified pages (e.g., from all candidate VMs) as available in the subject memory page pool (step 418₂).

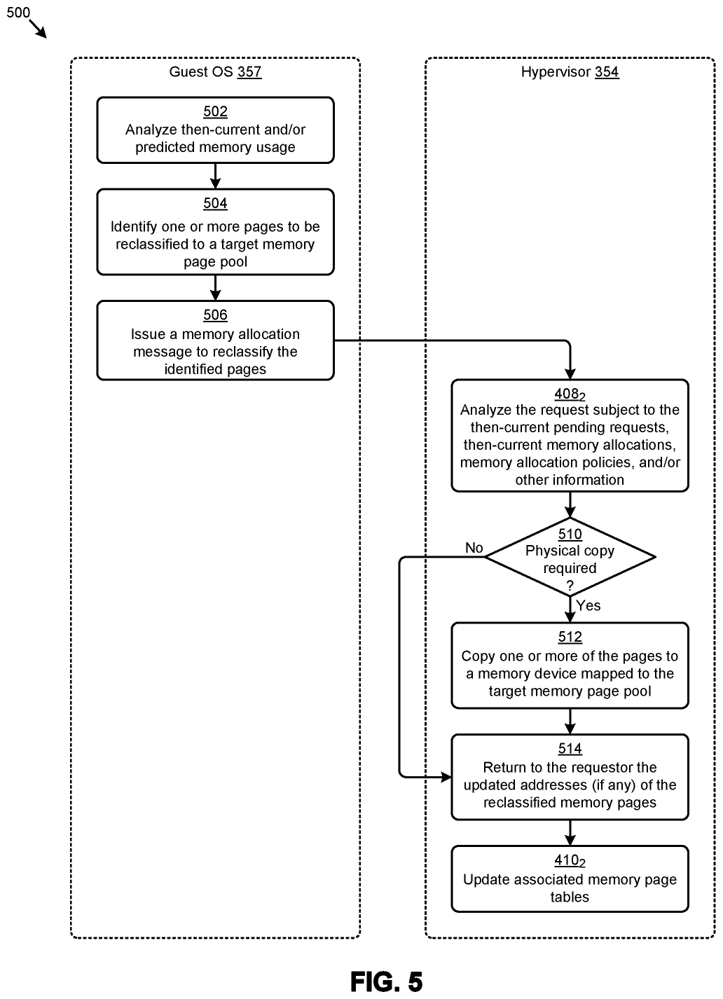

FIG. 5 presents a memory reclassification technique 500 as implemented in systems that facilitate cooperative memory management. As an option, one or more variations of memory reclassification technique 500 or any aspect thereof may be implemented in the context of the architecture and functionality of the embodiments described herein. The memory reclassification technique 500 or any aspect thereof may be implemented in any environment.

FIG. 5 illustrates one aspect pertaining to implementing memory reclassification operations within a framework that facilitates cooperative memory management by and between computing processes and an underlying operating system or hypervisor in a computing system. Specifically, the figure is presented to depict an embodiment of certain steps and/or operations that perform page reclassification operations (e.g., page promote operations, page demote operations, etc.) in accordance with the herein disclosed techniques.

As shown in memory reclassification technique 500, a first portion of the steps and/or operations can be executed at guest OS 357 (e.g., of a VM), and a second portion of the steps and/or operations can be executed at hypervisor 354. The memory reclassification technique 500 can commence by the guest OS 357 analyzing the then-current and/or predicted memory usage within the environment of the guest OS 357 (step 502). One or more pages to be reclassified to a target memory page pool are identified (step 504). A memory allocation message to reclassify the identified pages is issued (step 506). The hypervisor 354 analyzes the message subject to the other then-current pending requests, the then-current memory allocations, the memory allocation policies, and/or other information (step 408₂). If a physical memory data page copy is necessary (see “Yes” path of decision 510), the contents of one or more of the identified pages is copied to a memory device associated with the target memory page pool (step 512). For example, a “critical” data page to be reclassified as a “general” data page might be moved from a RAM device to an SSD device. When the physical memory page copies are completed, or no physical memory page copies are necessary (see “No” path of decision 510), the updated addresses (if any) of the reclassified memory pages are returned to the requestor (step 514). The associated page tables are then updated (step 410₂).

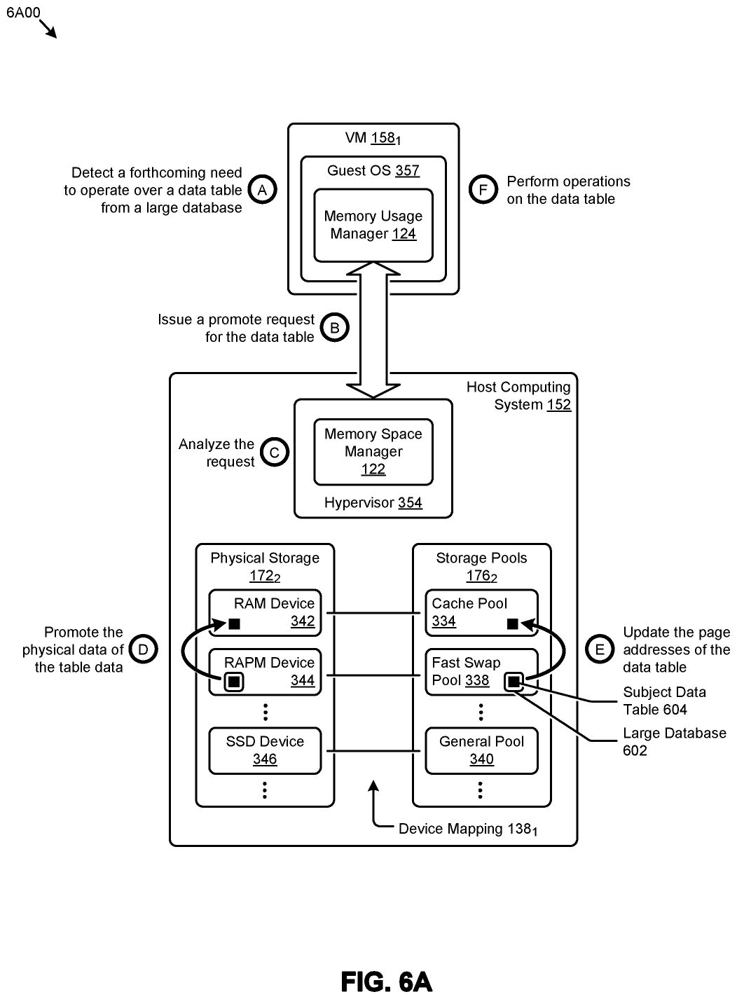

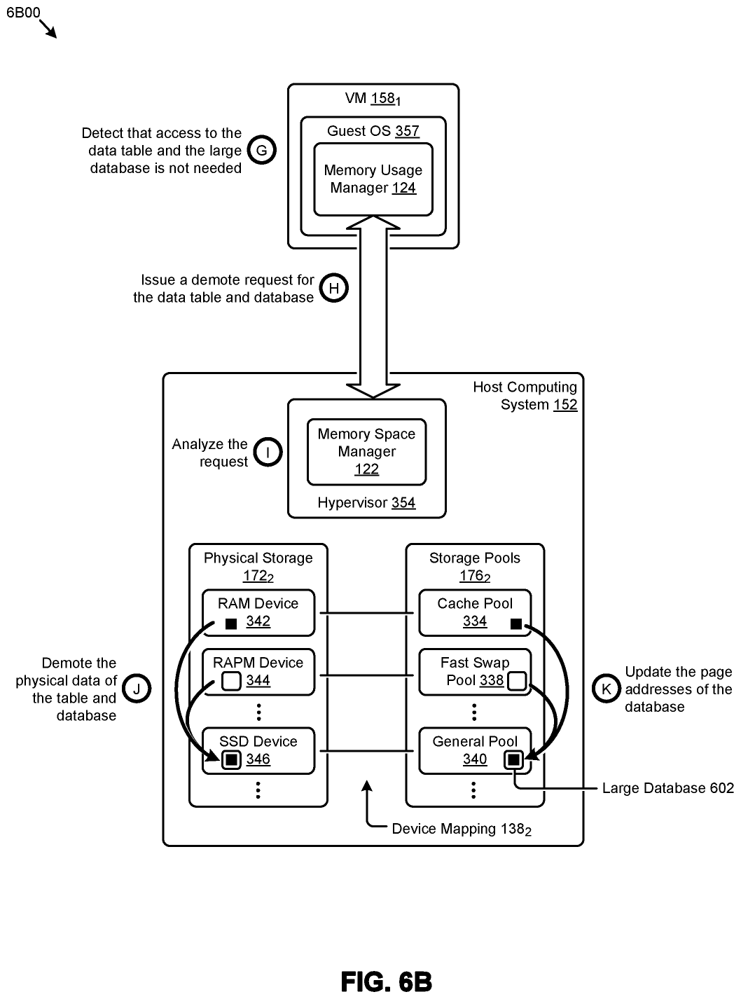

FIG. 6A and FIG. 6B illustrate page swapping scenarios as implemented in systems that facilitate cooperative memory management. As an option, one or more variations of page swapping scenarios or any aspect thereof may be implemented in the context of the architecture and functionality of the embodiments described herein. The page swapping scenarios or any aspect thereof may be implemented in any environment.

FIG. 6A and FIG. 6B illustrates one aspect pertaining to implementing page swapping operations 250 within a framework to facilitate cooperative memory management by and between computing processes and an underlying operating system or hypervisor. The figure is presented to illustrate an embodiment of the herein disclosed techniques that facilitate operational scenarios involving page swap in operations and page swap out operations. Specifically, FIG. 6A illustrates a promotion operation invoked by a computing process, and FIG. 6B illustrates a demotion operation invoked by a computing process.

As shown, page promotion scenario 6A00 is depicted using certain computing and/or functional components earlier described. In particular, FIG. 6A and FIG. 6B comprise the memory usage manager 124 implemented in guest OS 357 of VM 158₁. The memory usage manager 124 can alternatively be implemented in any functional block that is accessible to either the guest OS 357 or to a subject VM.

Also as shown, the memory space manager 122 is implemented in hypervisor 354 of host computing system 152. Host computing system 152 further includes physical storage 172₂ comprising a RAM device 342, a RAPM device 344, an SSD device 346, and/or other memory devices, and a storage pools 176₂ comprising a cache pool 334, a fast swap pool 338, a general pool 340, and/or other memory page pools. The devices of the physical storage 172₂ are mapped to the page pools of the storage pools 176₂ in accordance with the device mapping 138₁.

The page promotion scenario 6A00 can commence with detecting a forthcoming need to operate over a data table from a large database (operation A). For example, memory usage manager 124 might be aware that an application operating at VM 158₁ will soon need a subject data table 604 from a large database 602, which is then stored in data pages in the fast swap pool 338. Responsive to the memory allocation event triggered by the foregoing detection, a promote request for the data table is issued from the memory usage manager 124 to the memory space manager 122 (operation B). The memory space manager 122 analyzes the request (operation C) and proceeds to promote the physical data corresponding to the data table (operation D). For example, the physical data might be promoted from RAPM device 344 to RAM device 342. The addresses that point to the data table are updated to reflect the new location of the physical data (operation E). The result of the foregoing is that the subject data table 604 from the large database 602 is promoted from RAPM pages of the fast swap pool 338 to RAM pages of the cache pool 334. Using the updated addresses (e.g., updated in the virtual memory table at guest OS 357), VM 158₁ can then perform operations on the data table (operation F).

Page swapping-in/swapping-out and page promotion/demotion can be managed on the basis of the characteristics of known or predicted needs for memory space and/or for memory contents. For example, if some particular data from any source is known or predicted to be accessed repeatedly in some future processing, the memory manager might promote (e.g., copy) the “hot” data to a higher tier or memory (e.g., random access memory) while leaving the original contents intact in the lower tier of memory. When the data is deemed to be no longer “hot” the higher tier memory that had been serving the “hot” data can be released for use by other processes. As such, promotion operations copy data pages between page locations across multiple tiers of memory (e.g., from page locations in one memory tier to page locations in another memory tier) while keeping the data in both tiers intact for ongoing use. Swap-in and/or swap-out operations operate on data from source memory locations to bring the data into target memory locations, thus at least potentially releasing the resources at the source memory. In some cases of swap-in and/or swap-out operations, locations of the data contents of the source memory are immediately overwritten by one or more different processes. In some cases, locations of the data contents of the source memory might remain unmodified for some period of time until overwritten by one or more different processes.

Referring to FIG. 6B, page demotion scenario 6B00 is illustrated as commencing when memory usage manager 124 detects that access to the data table and the large database is no longer needed (operation G). A demote request for the data table and large database is issued from the memory usage manager 124 to the memory space manager 122 (operation H). The memory space manager 122 analyzes the request (operation I) and proceeds to demote the physical data corresponding to the data table and database (operation J). For example, the physical data might be demoted from RAM device 342 to RAPM device 344 and/or to SSD device 346 of physical storage 1722. The addresses that point to the new instance of the database (e.g., large database 602) are updated to reflect the new location of the physical data (operation K). One result of the foregoing is that the large database 602 and all its data tables are demoted from the RAM pages of the cache pool 334 and the RAPM pages of the fast swap pool 338 to the general pool 340.

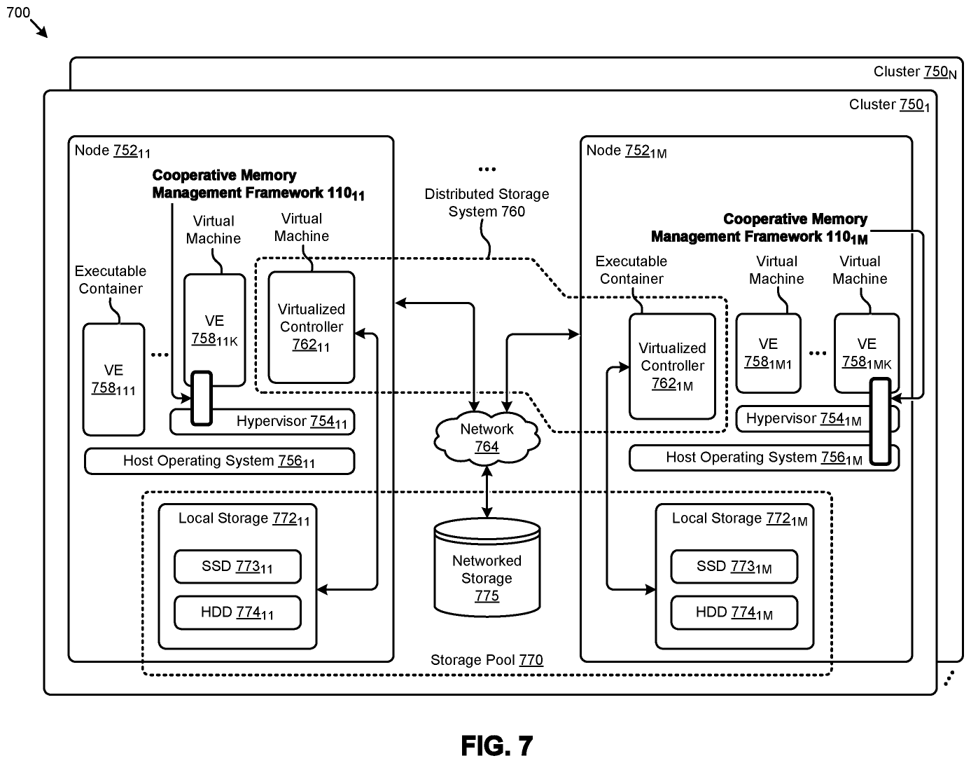

An example of a distributed computing environment (e.g., distributed virtualization environment, etc.) that supports any of the herein disclosed techniques is presented and discussed as pertains to FIG. 7.

FIG. 7 illustrates a distributed virtualization environment 700 in which embodiments of the present disclosure can be implemented. As an option, one or more variations of distributed virtualization environment 700 or any aspect thereof may be implemented in the context of the architecture and functionality of the embodiments described herein.

The shown distributed virtualization environment depicts various components associated with instances of distributed virtualization systems (e.g., hyperconverged distributed systems) that can be used to implement the herein disclosed techniques. Specifically, the distributed virtualization environment 700 comprises multiple clusters (e.g., cluster 750₁, . . . , cluster 750_{N}) comprising multiple nodes that have multiple tiers of storage in a storage pool. Representative nodes (e.g., node 752₁₁, . . . , node 752_{1M}) and storage pool 770 associated with cluster 750₁ are shown. Each node can be associated with one server, multiple servers, or portions of a server. The nodes can be associated (e.g., logically and/or physically) with the clusters. As shown, the multiple tiers of storage include storage that is accessible through a network 764, such as a networked storage 775 (e.g., a storage area network or SAN, network attached storage or NAS, etc.). The multiple tiers of storage further include instances of local storage (e.g., local storage 772₁₁, . . . , local storage 772_{1M}). For example, the local storage can be within or directly attached to a server and/or appliance associated with the nodes. Such local storage can include solid state drives (SSD 773₁₁, . . . , SSD 773_{1M}), hard disk drives (HDD 774₁₁, . . . , HDD 774_{1M}), and/or other storage devices.

As shown, any of the nodes of the distributed virtualization environment 700 can implement one or more user virtualized entities (e.g., VE 758₁₁₁, . . . , VE 758_{11K}, . . . , VE 758_{1M1}, . . . , VE 758_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 756₁₁, . . . , host operating system 756_{1M}), while the VMs run multiple applications on various respective guest operating systems. Such flexibility can be facilitated at least in part by a hypervisor (e.g., hypervisor 754₁₁, . . . , hypervisor 754_{1M}), which hypervisor is logically located between the various guest operating systems of the VMs and the host operating system of the physical infrastructure (e.g., node).

As an example, hypervisors can be implemented using virtualization software that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 756₁₁, . . . , host operating system 756_{1M}) without, in most cases, a hypervisor layer. This lightweight implementation can facilitate efficient distribution of certain software components, such as applications or services (e.g., micro-services. Any node of a distributed virtualization environment 700 can implement both a hypervisor-assisted virtualization environment and a container virtualization environment for various purposes. Also, any node in a distributed virtualization environment can implement a virtualized controller to facilitate access to storage pool 770 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a layer in a hypervisor).

Multiple instances of such virtualized controllers can coordinate within a cluster to form the distributed storage system 760 which can, among other operations, manage the storage pool 770. This architecture further facilitates efficient scaling in multiple dimensions (e.g., in a dimension of computing power, in a dimension of storage space, in a dimension of network bandwidth, etc.).

The foregoing virtualized controllers can be implemented in the distributed virtualization environment using various techniques. As one specific example, an instance of a virtual machine at a given node can be used as a virtualized controller in a hypervisor-assisted virtualization environment to manage storage and I/O (input/output or IO) activities. In this case, for example, the virtualized entities at node 752₁₁ can interface with a controller virtual machine (e.g., virtualized controller 762₁₁) through hypervisor 754₁₁ to access the storage pool 770. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 760. For example, a hypervisor at one node in the distributed storage system 760 might correspond to a first vendor's hypervisor, and a hypervisor at another node in the distributed storage system 760 might correspond to a second vendor's hypervisor. As another virtualized controller implementation example, containers (e.g., Docker containers) can be used to implement a virtualized controller (e.g., virtualized controller 762_{1M}) in an operating system virtualization environment at a given node. In this case, for example, the virtualized entities at node 752_{1M} can access the storage pool 770 by interfacing with a controller container (e.g., virtualized controller 762_{1M}) through hypervisor 754_{1M} and/or the kernel of host operating system 756_{1M}.

In certain embodiments, one or more instances of a cooperative memory management framework can be implemented over any of the components in the distributed virtualization environment 700 to facilitate the herein disclosed techniques. Specifically, cooperative memory management framework 110₁₁ can be implemented in one or more VEs (e.g., VE 758_{11K}) and/or one or more hypervisors (e.g., hypervisor 754₁₁) of node 752₁₁, and cooperative memory management framework 110_{1M} can be implemented in one or more VEs (e.g., VE 758_{1MK}), one or more hypervisors (e.g., hypervisor 754_{1M}), and/or host operating system 756_{1M} of node 752_{1M}. Such instances of the cooperative memory management framework can be implemented in any node in any cluster. Actions taken by one or more instances of the cooperative memory management framework can apply to a node (or between nodes), and/or to a cluster (or between clusters), and/or between any resources or subsystems accessible by the cooperative memory management framework, the virtualized controllers, and/or their agents.

As earlier described, the problems attendant to efficiently managing the allocation of memory to multiple computing processes can be addressed in the context of the foregoing environment. Moreover, any aspect or aspects of implementing a framework (e.g., cooperative memory management framework 110₁₁, cooperative memory management framework 110_{1M}, etc.) to facilitate cooperative memory management by and between computing processes (e.g., virtual machines, executable containers, etc.) and an underlying operating system (e.g., hypervisor, host operating system, etc.) in a computing

### Additional Embodiments of the Disclosure

### Additional Practical Application Examples

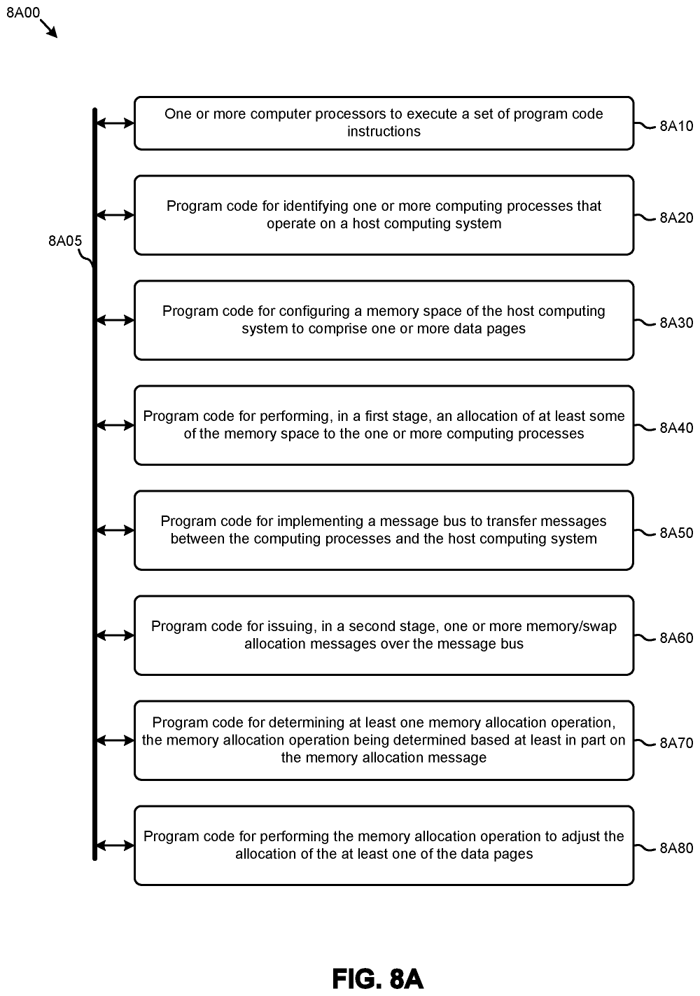

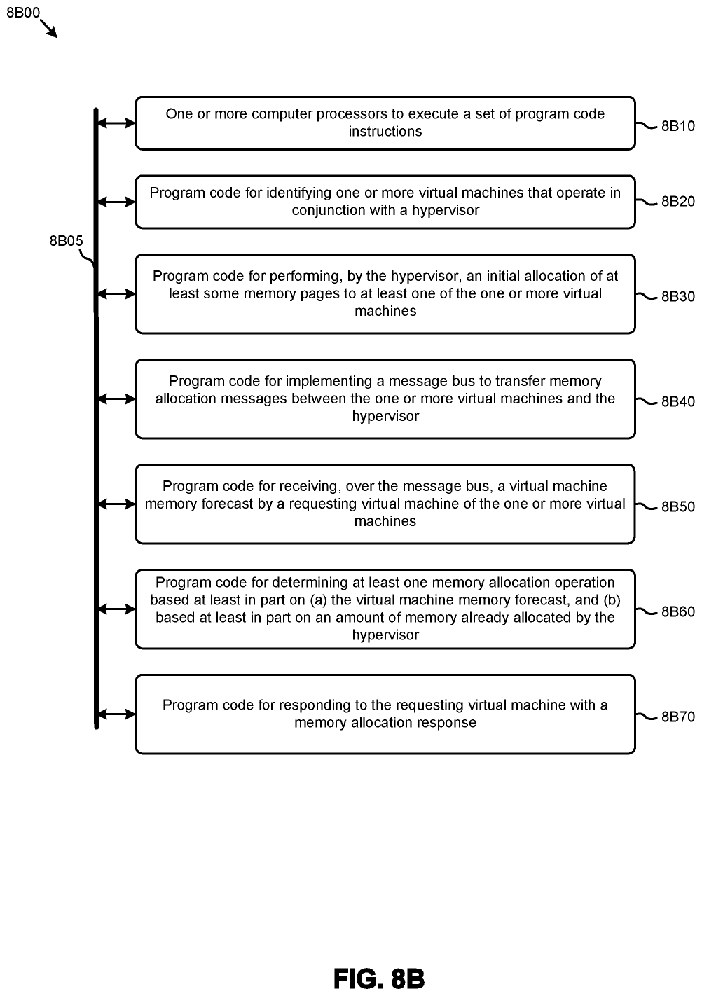

FIG. 8A depicts a system 8A00 as an arrangement of computing modules that are interconnected so as to operate cooperatively to implement certain of the herein-disclosed embodiments. This and other embodiments present particular arrangements of elements that, individually and/or as combined, serve to form improved technological processes that address efficiently managing the allocation of memory to multiple computing processes. The partitioning of system 8A00 is merely illustrative and other partitions are possible. As an option, the system 8A00 may be implemented in the context of the architecture and functionality of the embodiments described herein. Of course, however, the system 8A00 or any operation therein may be carried out in any desired environment.

The system 8A00 comprises at least one processor and at least one memory, the memory serving to store program instructions corresponding to the operations of the system. As shown, an operation can be implemented in whole or in part using program instructions accessible by a module. The modules are connected to a communication path 8A05, and any operation can communicate with other operations over communication path 8A05. The modules of the system can, individually or in combination, perform method operations within system 8A00. Any operations performed within system 8A00 may be performed in any order unless as may be specified in the claims.

The shown embodiment implements a portion of a computer system, presented as system 8A00, comprising one or more computer processors to execute a set of program code instructions (module 8A10) and modules for accessing memory to hold program code instructions to perform steps of: identifying one or more computing processes that operate on a host computing system (module 8A20); configuring a memory space of the host computing system to comprise one or more data pages (module 8A30); performing, in a first stage, an allocation of at least some of the memory space to the one or more computing processes (module 8A40); implementing a message bus to transfer messages between the computing processes and the host computing system (module 8A50); issuing, in a second stage, one or more memory/swap allocation messages over the message bus (module 8A60); determining at least one memory allocation operation, the memory allocation operation being determined based at least in part on the memory allocation message (module 8A70); and performing the memory allocation operation to adjust the allocation of the at least one of the data pages (module 8A80).

Variations of the foregoing may include more or fewer of the shown modules. Certain variations may perform more or fewer (or different) steps and/or certain variations may use data elements in more or in fewer (or different) operations.

Still further, some embodiments include variations in the operations performed, and some embodiments include variations of aspects of the data elements used in the operations. As examples, some embodiments are configured such than the determining of the at least one memory allocation operation comprises invoking a solver that considers memory allocations of more than one of the one or more computing processes. Some embodiments further comprise detecting at least one memory allocation event, wherein at least one of the one or more memory/swap allocation messages are issued in response to detecting the memory allocation event. Some embodiments are configured such than the data pages are organized into two or more memory page pools. Some embodiments are configured such that one or more memory/storage allocation operations move at least one of the data pages from a first memory page pool to a second memory page pool. Some embodiments are configured such that one or more memory devices are mapped to the memory page pools. Some embodiments are configured such than the memory allocation operation is one of, a page request operation, a page release operation, a page promote operation, a page demote operation, a page swap-in operation, or a page swap-out operation. Some embodiments are configured such than at least one of the one or more computing processes is a virtual machine or an executable container. Some embodiments are configured such than the one or more memory/swap allocation messages are received at the host computing system by at least one of, a hypervisor, or a host operating system. Some embodiments are configured such than the one or more memory/swap allocation messages are issued by at least one of the one or more computing processes or by the host computing system.

FIG. 8B depicts a system 8B00 as an arrangement of computing modules that are interconnected so as to operate cooperatively to implement certain of the herein-disclosed embodiments. The partitioning of system 8B00 is merely illustrative and other partitions are possible. As an option, the system 8B00 may be implemented in the context of the architecture and functionality of the embodiments described herein. Of course, however, the system 8B00 or any operation therein may be carried out in any desired environment.

The system 8B00 comprises at least one processor and at least one memory, the memory serving to store program instructions corresponding to the operations of the system. As shown, an operation can be implemented in whole or in part using program instructions accessible by a module. The modules are connected to a communication path 8B05, and any operation can communicate with other operations over communication path 8B05. The modules of the system can, individually or in combination, perform method operations within system 8B00. Any operations performed within system 8B00 may be performed in any order unless as may be specified in the claims.

The shown embodiment implements a portion of a computer system, presented as system 8B00, comprising a computer processor to execute a set of program code instructions (module 8B10) and modules for accessing memory to hold program code instructions to perform: identifying one or more virtual machines that operate in conjunction with a hypervisor (module 8B20); performing, by the hypervisor, an initial allocation of at least some memory pages to at least one of the one or more virtual machines (module 8B30); implementing a message bus to transfer memory/swap allocation messages between the one or more virtual machines and the hypervisor (module 8B40); receiving, over the message bus, a virtual machine memory forecast by a requesting virtual machine of the one or more virtual machines (module 8B50); determining at least one memory allocation operation based at least in part on (a) the virtual machine memory forecast, and (b) based at least in part on an amount of memory already allocated by the hypervisor (module 8B60); and responding to the requesting virtual machine with a memory allocation response (module 8B70).

### System Architecture Overview

### Additional System Architecture Examples

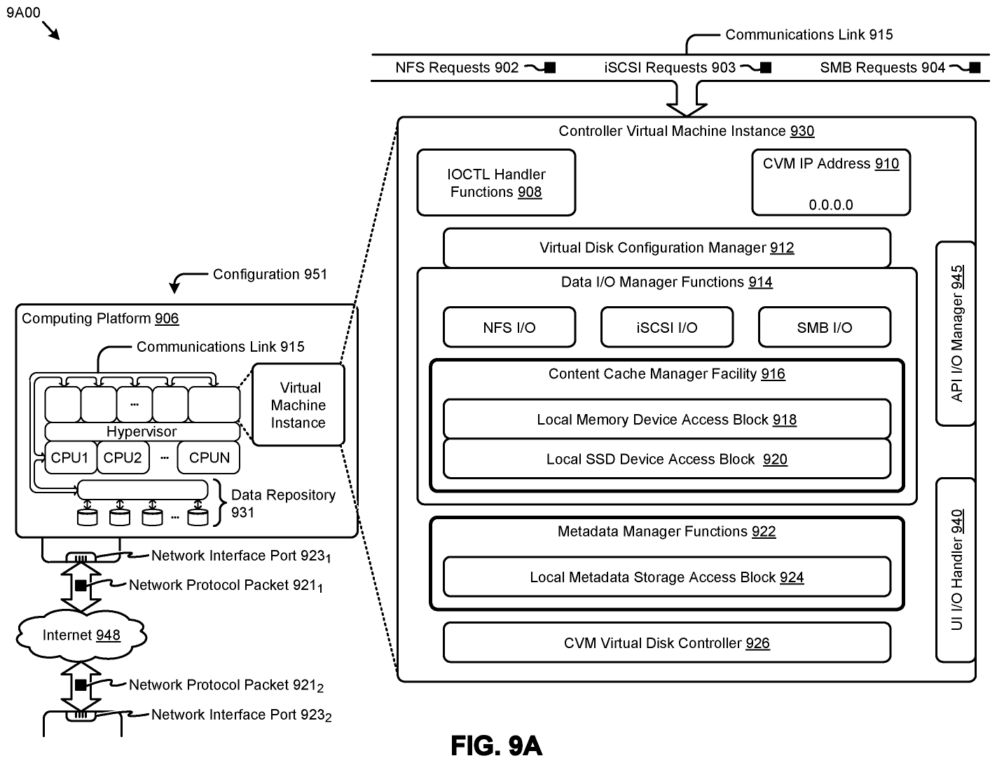

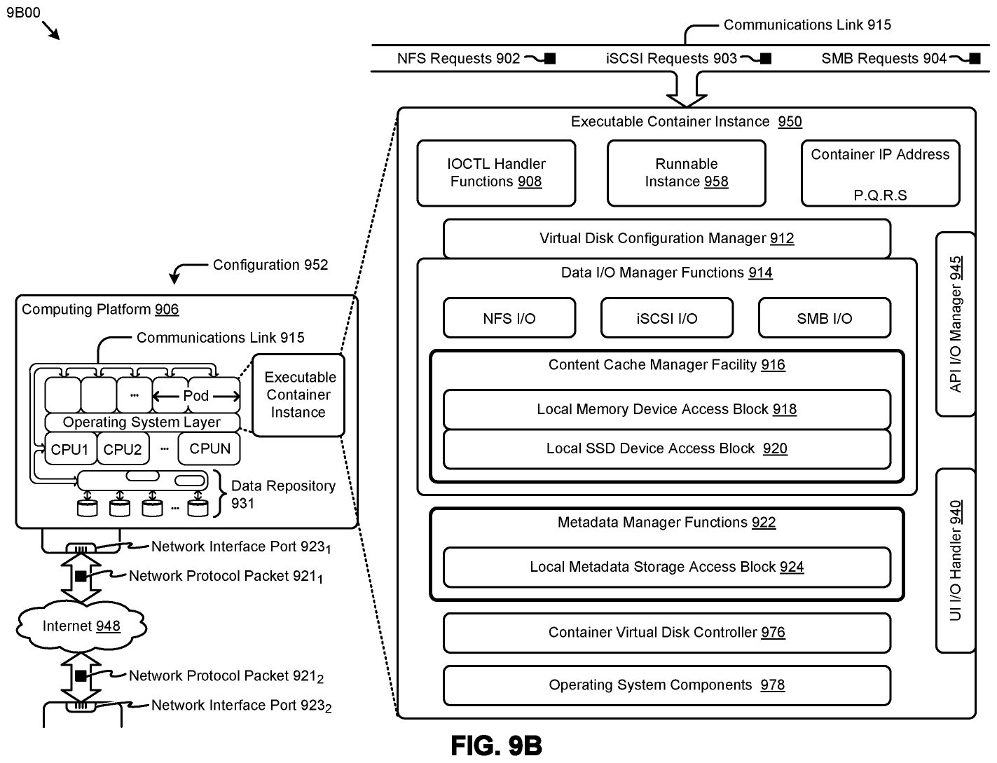

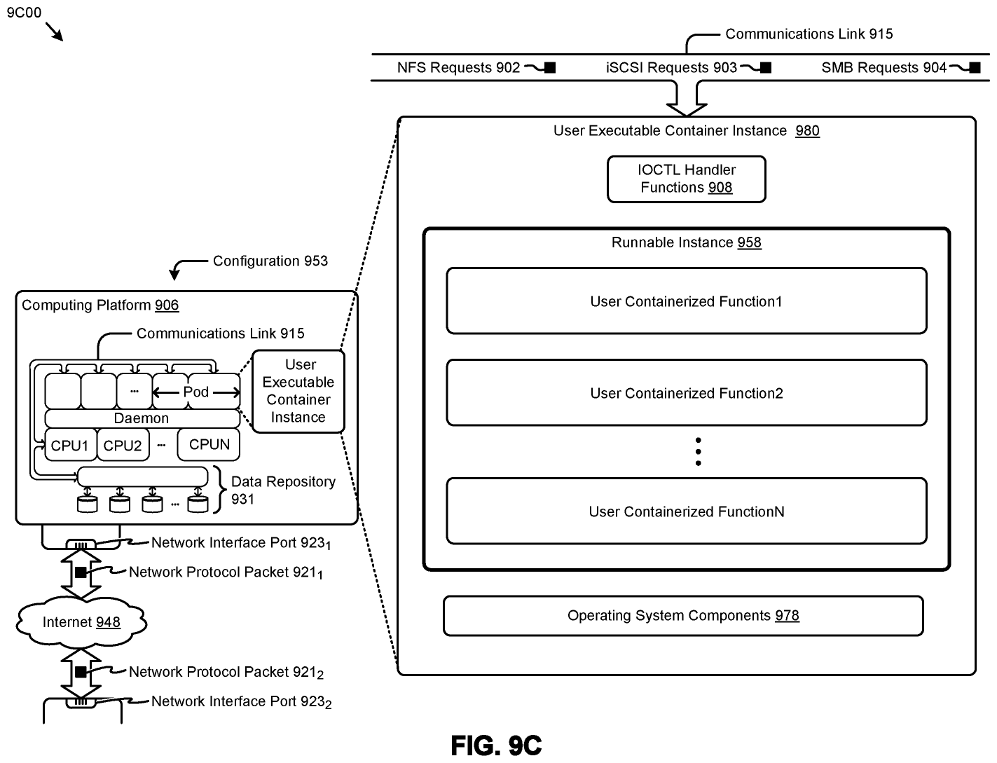

FIG. 9A depicts a virtualized controller as implemented by the shown virtual machine architecture 9A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 9A00 comprises a collection of interconnected components suitable for implementing embodiments of the present disclosure and/or for use in the herein-described environments. Moreover, virtual machine architecture 9A00 includes a virtual machine instance in configuration 951 that is further described as pertaining to controller virtual machine instance 930. Configuration 951 supports virtual machine instances that are deployed as user virtual machines, or controller virtual machines or both. Such virtual machines interface with a hypervisor (as shown). Some virtual machines include processing of storage I/O (input/output or JO) as received from any or every source within the computing platform. An example implementation of such a virtual machine that processes storage I/O is depicted as 930.

In this and other configurations, a controller virtual machine instance receives block I/O (input/output or JO) storage requests as network file system (NFS) requests in the form of NFS requests 902, and/or internet small computer storage interface (iSCSI) block JO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output (I/O or IO) can be handled by one or more IO control handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS JO, iSCSI JO, SMB JO, etc.).

In addition to block IO functions, configuration 951 supports IO of any form (e.g., block IO, streaming IO, packet-based IO, HTTP traffic, etc.) through either or both of a user interface (UI) handler such as UI IO handler 940 and/or through any of a range of application programming interfaces (APIs), possibly through API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 930 includes content cache manager facility 916 that accesses storage locations, possibly including local dynamic random access memory (DRAM) (e.g., through local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 931, which in turn can be formatted into any one or more storage areas, and which can comprise parameterized storage accessible by a key (e.g., a filename, a table name, a block address, an offset address, etc.). External data repository 931 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 924. External data repository 931 can be configured using CVM virtual disk controller 926, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 951 can be coupled by communications link 915 (e.g., backplane, LAN, PSTN, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 923₁ and network interface port 923₂). Configuration 951 can be addressed through one or more network interface ports using an IP address. Any operational element within computing platform 906 can perform sending and receiving operations using any of a range of network protocols, possibly including network protocols that send and receive packets (e.g., network protocol packet 921₁ and network protocol packet 921₂).

Computing platform 906 may transmit and receive messages that can be composed of configuration data and/or any other forms of data and/or instructions organized into a data structure (e.g., communications packets). In some cases, the data structure includes program code instructions (e.g., application code) communicated through the Internet 948 and/or through any one or more instances of communications link 915. Received program code may be processed and/or executed by a CPU as it is received and/or program code may be stored in any volatile or non-volatile storage for later execution. Program code can be transmitted via an upload (e.g., an upload from an access device over the Internet 948 to computing platform 906). Further, program code and/or the results of executing program code can be delivered to a particular user via a download (e.g., a download from computing platform 906 over the Internet 948 to an access device).

Configuration 951 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to cooperative memory management. In some embodiments, a module may include one or more state machines and/or combinational logic used to implement or facilitate the operational and/or performance characteristics pertaining to cooperative memory management.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of cooperative memory management). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to cooperative memory management, and/or for improving the way data is manipulated when performing computerized operations pertaining to implementing a framework to facilitate cooperative memory management by and between computing processes and an underlying operating system or hypervisor in a computing system.

Further details regarding general approaches to managing data repositories are described in U.S. Pat. No. 8,601,473titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance in configuration 952 that is further described as pertaining to executable container instance 950. Configuration 952 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls —a”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown daemon-assisted containerized architecture includes a user executable container instance in configuration 953 that is further described as pertaining to user executable container instance 980. Configuration 953 includes a daemon layer (as shown) that performs certain functions of an operating system.

User executable container instance 980 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this embodiment of a daemon-assisted containerized architecture, the computing platform 906 might or might not host operating system components other than operating system components 978. More specifically, the shown daemon might or might not host operating system components other than operating system components 978 of user executable container instance 980.

The virtual machine architecture 9A00 of FIG. 9A and/or the containerized architecture 9B00 of FIG. 9B and/or the daemon-assisted containerized architecture 9C00 of FIG. 9C can be used in any combination to implement a distributed platform that contains multiple servers and/or nodes that manage multiple tiers of storage, where the tiers of storage might be formed using the shown data repository 931 and/or any forms of network accessible storage. As such, the multiple tiers of storage may include storage that is accessible over the communications link 915. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual, since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments a vDisk is mountable. In some embodiments a vDisk is mounted as a virtual storage device.

In example embodiments, some or all of the servers or nodes run virtualization software. Such virtualization software might include a hypervisor (e.g., as shown in configuration 951 of FIG. 9A) to manage the interactions between the underlying hardware and user virtual machines or containers that run client software.

Distinct from user virtual machines or user executable containers, a special controller virtual machine (e.g., as depicted by controller virtual machine instance 930) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster. The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
receiving a memory allocation request from a virtual machine, the memory allocation request received at a hypervisor that runs in a host computer;
transferring the memory allocation request from the virtual machine to the hypervisor over a memory bus, the memory allocation request comprising a first memory allocation request for a first memory type having a first Get of performance characteristic and a second memory allocation request for a second memory type having a second performance characteristic; and
determining, by the hypervisor, a first allocation of a first memory page from the first memory type and a second allocation of a second memory page from the second memory type.

2. The method of claim 1, wherein the first memory allocation request and the second memory allocation request are communicated over a message bus between the virtual machine and the hypervisor.

3. The method of claim 1, further comprising determining a memory allocation operation that is based at least in part on a virtual machine memory forecast and an amount of memory already allocated by the hypervisor to another virtual machine.

4. The method of claim 3, wherein the determining of the memory allocation operation comprises invoking a solver that considers multiple memory allocation requests from a single virtual machine.

5. The method of claim 3, wherein the determining of the memory allocation operation comprises invoking a solver that considers memory allocations of multiple virtual machines.

6. The method of claim 3, wherein the determining of the memory allocation operation comprises invoking a solver that determines the memory allocation operation based at least on part upon two cost functions corresponding to different types of memory.

7. The method of claim 1, further comprising organizing memory of the multiple types of memories first type and the second type into multiple pools.

8. The method of claim 7, wherein a pool of the multiple pools comprises a multi-memory pool that is backed by multiple different memory types.

9. The method of claim 1, further comprising performing a storage allocation operation to move contents of a memory device of the second memory type to of a storage device.

10. The method of claim 9, wherein the storage allocation operation is responsive to at least one of a page request operation, a page release operation, a page promote operation, or a page demote operation.

11. A non-transitory computer readable medium, having stored thereon a sequence of instructions which, when stored in memory and executed by a processor, causes the processor to perform a set of acts, the set of acts comprising:
receiving a memory allocation request from a virtual machine, the memory allocation request received at a hypervisor that runs in a host computer;
transferring the memory allocation request from the virtual machine to the hypervisor over a memory bus, the memory allocation request comprising a first memory allocation request for a first memory type having a first performance characteristic and a second memory allocation request for a second memory type having a second performance characteristic; and
determining, by the hypervisor, a first allocation of a first memory page from the first memory type and a second allocation of a second memory page from the second memory type.

12. The non-transitory computer readable medium of claim 11, wherein the first memory allocation request and the second memory allocation request are communicated over a message bus between the virtual machine and the hypervisor.

13. The non-transitory computer readable medium of claim 11, further comprising instructions which, when stored in the memory and executed by the processor, causes the processor to perform the set of acts that further comprising determining a memory allocation operation that is based at least in part on a virtual machine memory forecast and an amount of memory already allocated by the hypervisor to another virtual machine.

14. The non-transitory computer readable medium of claim 13, wherein determining the memory allocation operation comprises invoking a solver that considers multiple memory allocation requests from a single virtual machine machines.

15. The non-transitory computer readable medium of claim 13, wherein determining the memory allocation operation comprises invoking a solver that considers memory allocations of multiple virtual machines.

16. The non-transitory computer readable medium of claim 13, wherein determining the memory allocation operation comprises invoking a solver that determines the memory allocation operation based at least in part upon two cost functions corresponding to different types of memory.

17. The non-transitory computer readable medium of claim 11, further comprising instructions which, when stored in the memory and executed by the processor, causes the processor to perform the set of acts that further comprising organizing memory of the first type and the second type into multiple pools.

18. The non-transitory computer readable medium of claim 17, wherein a pool of the multiple pools comprises a multi-memory pool that is backed by multiple different memory types.

19. A system, comprising:
a non-transitory storage medium having stored thereon a sequence of instructions; and
a processor that executes the sequence of instructions, an execution of the sequence of instructions causes the processor to perform a set of acts, the set of acts comprising,
receiving a memory allocation request from a virtual machine, the memory allocation request received at a hypervisor that runs in a host computer;
transferring the memory allocation request from the virtual machine to the hypervisor over a memory bus, the memory allocation request comprising a first memory allocation request for a first memory type having a first performance characteristic and a second memory allocation request for a second memory type having a second performance characteristic; and
determining, by the hypervisor, a first allocation of at least one memory page from the first memory type and a second allocation of at least one memory page from the second memory type.

20. The system of claim 19, wherein the first memory allocation request and the second memory allocation request are communicated over a message bus between the virtual machine and the hypervisor.
